(19) United States
(12) Patent Application Publication
(10) Pub. No.: US 2026/0331855 A1
(43) Pub. Date: Oct. 22, 2026

(54) LASER CHAMBER, GAS LASER DEVICE, AND ELECTRONIC DEVICE MANUFACTURING METHOD

(71) Applicant: Gigaphoton Inc., Tochigi (JP)

(72) Inventors: Hiroshi UMEDA, Oyama-shi (JP); Takashi ITO, Oyama-shi (JP)

(73) Assignee: Gigaphoton Inc., Tochigi (JP)

(21) Appl. No.: 19/553,739

(22) Filed: Mar. 2, 2026

(30) Foreign Application Priority Data
Apr. 17, 2025 (JP) 2025-068164

(51) Int. Cl. H01S 3/036; H01S 3/038

(52) U.S. Cl. CPC H01S 3/036; H01S 3/0384

(57) ABSTRACT

A laser chamber includes a container filled with a laser gas, a first electrode arranged in the container, a second electrode arranged at a position closer to an inner wall of the container than the first electrode while facing the first electrode, a fan configured to cause the laser gas to flow through a discharge space between the first electrode and the second electrode, and an insulating guide arranged at least either on upstream or downstream of the second electrode in flow of the laser gas. Here, a plurality of grooves are formed on a surface of the insulating guide in a direction parallel to a direction in which the laser gas flows. The plurality of grooves include a combination of two adjacent grooves having cross-sectional shapes different from each other, the cross-sectional shapes being taken along a plane perpendicular to the direction in which the laser gas flows.

### CROSS-REFERENCE TO RELATED APPLICATIONS

The present application is a continuation application of Japanese Patent Application No. 2025-068164, filed on Apr. 17, 2025, the entire contents of which are hereby incorporated by reference.

### BACKGROUND

### 1. Technical Field

The present disclosure relates to a laser chamber, a gas laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: International Publication No. WO1999/045614

Patent Document 2: US Patent Application Publication No. 2016/0308324

Patent Document 3: Japanese Patent Application Publication No. H6-85350

### SUMMARY

A laser chamber according to an aspect of the present disclosure includes a container filled with a laser gas, a first electrode arranged in the container, a second electrode arranged at a position closer to an inner wall of the container than the first electrode while facing the first electrode, a fan configured to cause the laser gas to flow through a discharge space between the first electrode and the second electrode, and an insulating guide arranged at least either on upstream or downstream of the second electrode in flow of the laser gas. Here, a plurality of grooves are formed on a surface of the insulating guide in a direction parallel to a direction in which the laser gas flows. The plurality of grooves include a combination of two adjacent grooves having cross-sectional shapes different from each other, the cross-sectional shapes being taken along a plane perpendicular to the direction in which the laser gas flows.

A gas laser device according to an aspect of the present disclosure includes an optical resonator, and a laser chamber arranged so that an optical path of the optical resonator passes therethrough. Here, the laser chamber includes a container filled with a laser gas, a first electrode arranged in the container, a second electrode arranged at a position closer to an inner wall of the container than the first electrode while facing the first electrode, a fan configured to cause the laser gas to flow through a discharge space between the first electrode and the second electrode, and an insulating guide arranged at least either on upstream or downstream of the second electrode in flow of the laser gas. A plurality of grooves are formed on a surface of the insulating guide in a direction parallel to a direction in which the laser gas flows. The plurality of grooves include a combination of two adjacent grooves having cross-sectional shapes different from each other, the cross-sectional shapes being taken along a plane perpendicular to the direction in which the laser gas flows.

An electronic device manufacturing method according to an aspect of the present disclosure includes generating laser light using a gas laser device, outputting the laser light to an exposure apparatus, and exposing a photosensitive substrate to the laser light in the exposure apparatus to manufacture an electronic device. Here, the gas laser device includes an optical resonator, and a laser chamber arranged so that an optical path of the optical resonator passes therethrough. The laser chamber includes a container filled with a laser gas, a first electrode arranged in the container, a second electrode arranged at a position closer to an inner wall of the container than the first electrode while facing the first electrode, a fan configured to cause the laser gas to flow through a discharge space between the first electrode and the second electrode, and an insulating guide arranged at least either on upstream or downstream of the second electrode in flow of the laser gas. A plurality of grooves are formed on a surface of the insulating guide in a direction parallel to a direction in which the laser gas flows. The plurality of grooves include a combination of two adjacent grooves having cross-sectional shapes different from each other, the cross-sectional shapes being taken along a plane perpendicular to the direction in which the laser gas flows.

### BRIEF DESCRIPTION OF THE DRAWINGS

Embodiments of the present disclosure will be described below merely as examples with reference to the accompanying drawings.

FIG. 1 is a side view schematically showing the configuration of a gas laser device according to a comparative example.

FIG. 2 is a sectional view schematically showing the configuration of the gas laser device according to the comparative example.

FIG. 3 is a sectional view schematically showing a part including a main electrode in a laser chamber.

FIG. 4 is a sectional view schematically showing a part including the main electrode in the laser chamber according to an embodiment.

FIG. 5 is a plane view showing a surface of an insulating guide.

FIG. 6 is a sectional view showing a cross section taken along line A-A of FIG. 5.

FIG. 7 is a side view showing the configuration of a groove viewed from a direction of a side surface.

FIG. 8 is a sectional view showing a cross section of the insulating guide according to a first modification.

FIG. 9 is a side view showing the configuration of the groove of the insulating guide according to a second modification viewed from the direction of the side surface.

FIG. 10 is a plane view showing the surface of the insulating guide according to a third modification.

FIG. 11 is a sectional view showing a cross section taken along line B-B of FIG. 10.

FIG. 12 is a sectional view showing a cross section of the insulating guide according to a fourth modification.

FIG. 13 is a diagram schematically showing a configuration example of an exposure apparatus.

### DESCRIPTION OF EMBODIMENTS

### Contents

1. Comparative example
   1.1 Configuration
   1.2 Operation
   1.3 Problem
2. Embodiment
   2.1 Configuration
   2.2 Operation
   2.3 Effect
3. Modification
   3.1 First modification
   3.2 Second modification
   3.3 Third modification
   3.4 Fourth modification
4. Electronic device manufacturing method

Hereinafter, embodiments of the present disclosure will be described in detail with reference to the drawings. The embodiments described below shows some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

First, a comparative example of the present disclosure will be described. The comparative example of the present disclosure is an example recognized by the applicant as known only by the applicant, and is not a publicly known example admitted by the applicant.

### 1.1 Configuration

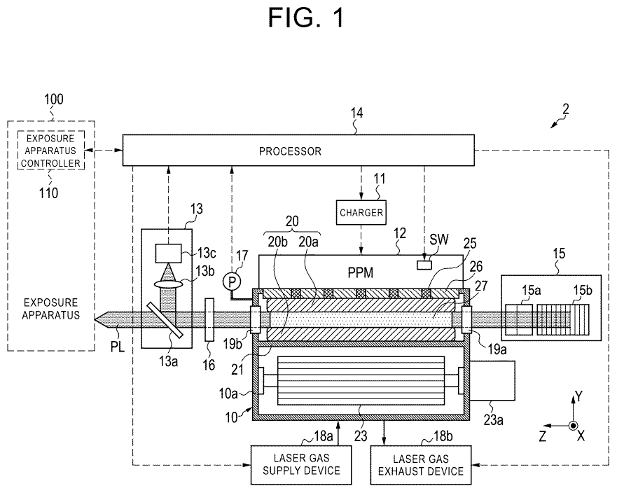

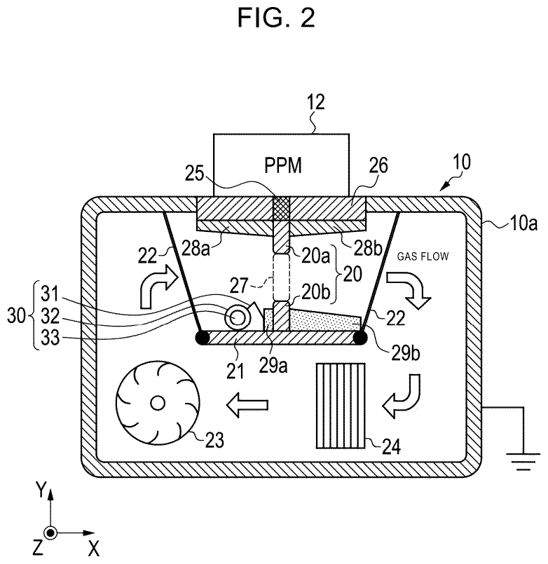

The configuration of a gas laser device 2 according to the comparative example will be described using FIGS. 1 and 2. FIG. 1 schematically shows the configuration of the gas laser device 2. FIG. 2 is a sectional view of the gas laser device 2 shown in FIG. 1 viewed from a Z direction. The gas laser device 2 is a discharge-excitation-type gas laser device that causes discharge and excites a laser gas, and is, for example, an excimer laser device.

In FIG. 1, the travel direction of pulse laser light PL output from the gas laser device 2 is defined as the Z direction. A discharge direction to be described later is defined as a Y direction. A direction orthogonal to the Z direction and the Y direction is defined as an X direction. Here, the pulse laser light PL is an example of the “laser light” according to the technology of the present disclosure.

The gas laser device 2 is a line narrowing gas laser device including a laser chamber 10, a charger 11, a pulse power module (PPM) 12, a pulse energy measurement unit 13, a processor 14, a pressure sensor 17, and a laser resonator. The laser resonator is configured of a line narrowing module 15 and an output coupling mirror 16.

The laser chamber 10 includes, for example, a container 10a made of aluminum metal plated with nickel on the surface thereof. As shown in FIGS. 1 and 2, a main electrode 20, a ground plate 21, return plates 22, a fan 23, a heat exchanger 24, insulating guides 28a, 28b, sound absorbing materials 29a, 29b, and a preionization electrode 30 are provided in the container 10a. The preionization electrode 30 includes a preionization outer electrode 31, a dielectric pipe 32, and a preionization inner electrode 33.

A laser gas containing fluorine as a laser medium is enclosed in the container 10a. The laser gas includes, for example, argon, krypton, xenon, or the like as a rare gas, neon, helium, or the like as a buffer gas, and fluorine, chlorine, or the like as a halogen gas.

Further, an opening is formed in the container 10a. An electrically insulating plate 26 in which a feedthrough 25 is embedded is attached to the container 10a via an O-ring (not shown) so as to close the opening. The PPM 12 is arranged on the electrically insulating plate 26. The container 10a is grounded.

The PPM 12 includes a charging capacitor (not shown) and is connected to the main electrode 20 via the feedthrough 25. The PPM 12 includes a switch SW for causing discharge to occur at the main electrode 20. The charger 11 is connected to the charging capacitor of the PPM 12. Hereinafter, the discharge occurring at the main electrode 20 is referred to as main discharge.

The main electrode 20 includes a cathode electrode 20a and an anode electrode 20b. The cathode electrode 20a and the anode electrode 20b are arranged in the container 10a so that discharge surfaces of both thereof face each other. The space between the discharge surface of the cathode electrode 20a and the discharge surface of the anode electrode 20b is referred to as a discharge space 27. Each of the cathode electrode 20a and the anode electrode 20b extends in the Z direction.

The cathode electrode 20a is supported by the electrically insulating plate 26 on a surface opposite to the discharge surface thereof, and is connected to the feedthrough 25. That is, the cathode electrode 20a is arranged at a position closer to the inner wall of the container 10a than the anode electrode 20b while facing the anode electrode 20b. The anode electrode 20b is supported by the ground plate 21 on a surface opposite to the discharge surface thereof. The anode electrode 20b is an example of the “first electrode” according to the technology of the present disclosure. The cathode electrode 20a is an example of the “second electrode” according to the technology of the present disclosure.

The ground plate 21 is connected to the container 10a via the return plates 22. The container 10a is grounded. Therefore, the ground plate 21 is grounded via the return plates 22. An end part of the ground plate 21 in the Z direction is fixed to the container 10a.

The fan 23 is a cross flow fan for circulating the laser gas in the container 10a, and is arranged on the opposite side of the discharge space 27 with respect to the ground plate 21. A motor 23a for rotationally driving the fan 23 is connected to the container 10a.

The laser gas blown out from the fan 23 flows into the discharge space 27. The flow direction of the laser gas flowing into the discharge space 27 is substantially parallel to the X direction. The laser gas flowing out from the discharge space 27 is sucked into the fan 23 via the heat exchanger 24. The heat exchanger 24 changes the temperature of the laser gas by performing heat exchange between a refrigerant supplied to the inside of the heat exchanger 24 and the laser gas.

The insulating guides 28a, 28b are arranged on a surface of the electrically insulating plate 26 facing the discharge space 27 so as to sandwich the cathode electrode 20a. The insulating guide 28a is arranged upstream of the cathode electrode 20a in flow of the laser gas. The insulating guide 28b is arranged downstream of the cathode electrode 20a in flow of the laser gas.

The insulating guides 28a, 28b are formed in a shape to guide the flow of the laser gas so that the laser gas from the fan 23 efficiently flows between the cathode electrode 20a and the anode electrode 20b. The insulating guides 28a, 28b and the electrically insulating plate 26 are made of, for example, ceramics such as alumina (Al₂O₃) having low reactivity with a fluorine gas.

The sound absorbing materials 29a, 29b are arranged on a surface of the ground plate 21 facing the discharge space 27 so as to sandwich the anode electrode 20b. The sound absorbing material 29a is arranged upstream of the anode electrode 20b in flow of the laser gas. The sound absorbing material 29b is arranged downstream of the anode electrode 20b in flow of the laser gas.

The sound absorbing materials 29a, 29b are made of, for example, a porous material. The porous material forming the sound absorbing materials 29a, 29b is at least one of a porous metal, a foamed metal, and a mesh metal. These are metal materials having low reactivity with the laser gas and include, for example, at least one of nickel, aluminum, and copper. The sound absorbing materials 29a, 29b guide the laser gas from the fan 23 to flow efficiently between the cathode electrode 20a and the anode electrode 20b, and absorb an acoustic wave generated by main discharge.

A laser gas supply device 18a and a laser gas exhaust device 18b are connected to the laser chamber 10. The laser gas supply device 18a includes a valve and a flow rate control valve, and is connected to a gas cylinder accommodating the laser gas. The laser gas exhaust device 18b includes a valve and an exhaust pump.

At end parts of the container 10a, windows 19a, 19b for outputting light generated in the container 10a to the outside are provided, respectively. The laser chamber 10 is arranged such that the optical path of the optical resonator passes through the discharge space 27 and the windows 19a, 19b.

The line narrowing module 15 includes a prism 15a and a grating 15b. The prism 15a transmits the light output from the laser chamber 10 through the window 19a toward the grating 15b while expanding the beam width of the light.

The grating 15b is arranged in the Littrow arrangement so that the incident angle and the diffraction angle are the same. The grating 15b is a wavelength selection element that selectively extracts light having a wavelength near a particular wavelength in accordance with the diffraction angle. The spectral width of the light returning from the grating 15b to the laser chamber 10 via the prism 15a is line-narrowed.

The output coupling mirror 16 transmits a part of the light output from the laser chamber 10 through the window 19b, and reflects the other part back into the laser chamber 10. The surface of the output coupling mirror 16 is coated with a partial reflection film.

Light output from the laser chamber 10 reciprocates between the line narrowing module 15 and the output coupling mirror 16, and is amplified each time the light passes through the discharge space 27. A part of the amplified light is output as the pulse laser light PL via the output coupling mirror 16. The wavelength of the pulse laser light PL is in an ultraviolet range of 150 nm to 380 nm, and is, for example, an oscillation wavelength of an excimer laser device.

The pulse energy measurement unit 13 is arranged on the optical path of the pulse laser light PL output via the output coupling mirror 16. The pulse energy measurement unit 13 includes a beam splitter 13a, a light concentrating optical system 13b, and an optical sensor 13c.

The beam splitter 13a transmits the pulse laser light PL with a high transmittance and reflects a part of the pulse laser light PL toward the light concentrating optical system 13b. The light concentrating optical system 13b concentrates the light reflected by the beam splitter 13a on a light receiving surface of the optical sensor 13c. The optical sensor 13c measures the pulse energy of the light concentrated on the light receiving surface, and outputs the measurement value to the processor 14.

The pressure sensor 17 detects the gas pressure in the container 10a, and outputs the detection value to the processor 14. The processor 14 determines the gas pressure of the laser gas in the container 10a based on the detection value of the gas pressure and the charge voltage of the charger 11.

The charger 11 is a high voltage power source that supplies the charge voltage to the charging capacitor included in the PPM 12. The switch SW of the PPM 12 is controlled by the processor 14. When the switch SW is turned ON from OFF, the PPM 12 generates a high voltage pulse from the electric energy held in the charging capacitor and applies the high voltage pulse to the main electrode 20.

The processor 14 is a processing device, such as a central processing unit (CPU), that transmits and receives various signals to and from an exposure apparatus controller 110 provided in an exposure apparatus 100. For example, the exposure apparatus controller 110 transmits, to the processor 14, a target pulse energy of the pulse laser light PL to be output to the exposure apparatus 100, an oscillation trigger signal, and the like.

The processor 14 generally controls operation of each component of the gas laser device 2 based on various signals transmitted from the exposure apparatus controller 110, the measurement value of the pulse energy, the detection value of the gas pressure, and the like.

Here, the gas laser device 2 is not necessarily limited to a line narrowing laser device, and may be a laser device that outputs natural oscillation light. For example, a high reflection mirror may be arranged in place of the line narrowing module 15.

### 1.2 Operation

Next, operation of the gas laser device 2 according to the comparative example will be described. First, the processor 14 controls the laser gas supply device 18a to supply the laser gas into the container 10a of the laser chamber 10, and drives the motor 23a to rotate the fan 23. As a result, as indicated by arrows in FIG. 2, the laser gas filled in the container 10a circulates.

The processor 14 receives the target pulse energy and the oscillation trigger signal from the exposure apparatus controller 110. Here, the oscillation trigger signal is a signal for instructing the gas laser device 2 to output one pulse of the pulse laser light PL.

The processor 14 sets the charge voltage corresponding to the target pulse energy in the charger 11. The processor 14 operates the switch SW of the PPM 12 in synchronization with the oscillation trigger signal.

When the switch SW of the PPM 12 is turned ON from OFF, a voltage is applied to each between the preionization inner electrode 33 and the preionization outer electrode 31 of the preionization electrode 30 and between the cathode electrode 20a and the anode electrode 20b. As a result, corona discharge occurs in the preionization electrode 30, and ultraviolet (UV) light is generated. When the laser gas in the discharge space 27 is irradiated with the UV light, the laser gas is preionized.

Thereafter, when the voltage between the cathode electrode 20a and the anode electrode 20b reaches a breakdown voltage, main discharge occurs in the discharge space 27. When the discharge direction of main discharge is defined as a direction in which electrons flow, the discharge direction is the direction from the cathode electrode 20a toward the anode electrode 20b. When main discharge occurs, the laser gas in the discharge space 27 is excited to emit light.

The light emitted from the laser gas is reflected by the line narrowing module 15 and the output coupling mirror 16 and reciprocates in the laser resonator, thereby performing laser oscillation. The light line-narrowed by the line narrowing module 15 is output from the output coupling mirror 16 as the pulse laser light PL.

A part of the pulse laser light PL output from the output coupling mirror 16 enters the pulse energy measurement unit 13. The pulse energy measurement unit 13 measures the pulse energy of the entering pulse laser light PL, and outputs the measurement value to the processor 14.

The processor 14 calculates a difference ΔE between the measurement value of the pulse energy and the target pulse energy. The processor 14 performs feedback control on the charge voltage so that the difference ΔE approaches zero.

When the charge voltage is higher than a maximum value of an allowable range, the processor 14 controls the laser gas supply device 18a to supply the laser gas into the container 10a until a predetermined pressure is reached. Further, when the charge voltage is lower than a minimum value of the allowable range, the processor 14 controls the laser gas exhaust device 18b to exhaust the laser gas from the container 10a until a predetermined pressure is reached.

The pulse laser light PL transmitted through the pulse energy measurement unit 13 enters the exposure apparatus 100.

In the container 10a, discharge products are generated by main discharge in the discharge space 27. The generated discharge products are moved away from the discharge space 27 by the gas flow generated by the fan 23. Thus, discharge can be stabilized. Further, the temperature of the laser gas increases by main discharge. The laser gas having the increased temperature is cooled by cooling water flowing in the heat exchanger 24 while passing through the heat exchanger 24.

Further, the acoustic wave is generated by the main discharge. The generated acoustic wave is attenuated by being absorbed by the sound absorbing materials 29a, 29b.

### 1.3 Problem

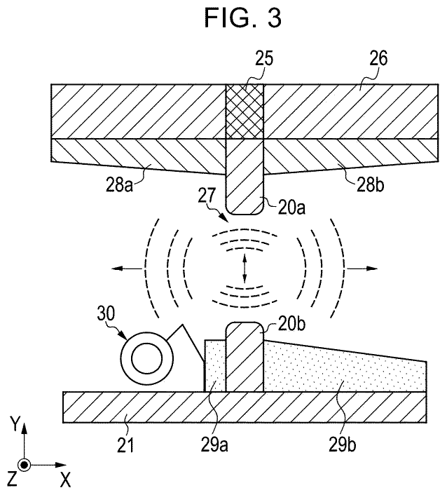

FIG. 3 schematically shows a part including the main electrode 20 in the laser chamber 10 according to the comparative example. Broken lines shown in FIG. 3 schematically show the acoustic wave generated by main discharge. As shown in FIG. 3, the acoustic wave generated by main discharge is a compression wave of the laser gas and propagates while spreading from the discharge space 27. The acoustic wave may remain in the discharge space 27 at a timing at which main discharge occurs next, or may be reflected by a structural object in the container 10a such as the insulating guides 28a, 28b and return to the discharge space 27. When main discharge occurs while the acoustic wave remains in the discharge space 27 as described above, the laser performance such as the spectral line width of the pulse laser light PL may be adversely affected.

Therefore, in the gas laser device 2 according to the comparative example, the sound absorbing materials 29a, 29b are arranged in the vicinity of the discharge space 27 to attenuate the acoustic wave.

However, when the repetition frequency of the pulse laser light PL is increased, the time interval of main discharge is shortened, and therefore, subsequent main discharge may be started before the acoustic wave generated by previous main discharge is sufficiently attenuated by the sound absorbing materials 29a, 29b. As a result, the phenomenon in which the acoustic wave remains in the discharge space 27 becomes pronounced, and there is a possibility that the adverse effect on the laser performance as described above becomes large. Therefore, it is desirable to attenuate the acoustic wave returning to the discharge space 27 more effectively.

In view of the above problems, an object of the present disclosure is to effectively attenuate the acoustic wave returning to the discharge space 27.

### 2. Embodiment

### 2.1 Configuration

The gas laser device 2 according to an embodiment of the present disclosure has the same configuration as the gas laser device 2 according to the comparative example except that the configuration in the laser chamber 10 is different.

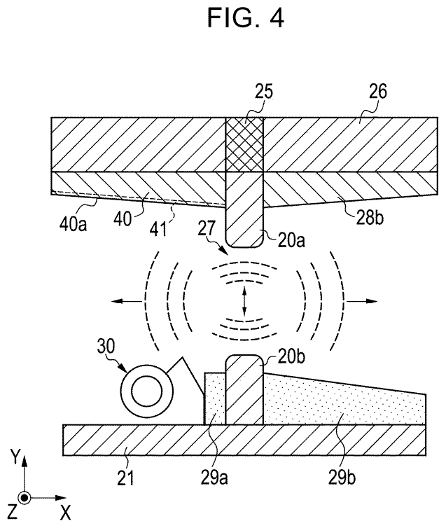

FIG. 4 schematically shows a part including the main electrode 20 in the laser chamber 10 according to the embodiment. In the present embodiment, an insulating guide 40 in which a plurality of grooves 41 are formed is provided instead of the insulating guide 28a. The insulating guide 40 has the same configuration as the insulating guide 28a except that the plurality of grooves 41 are formed on a surface 40a.

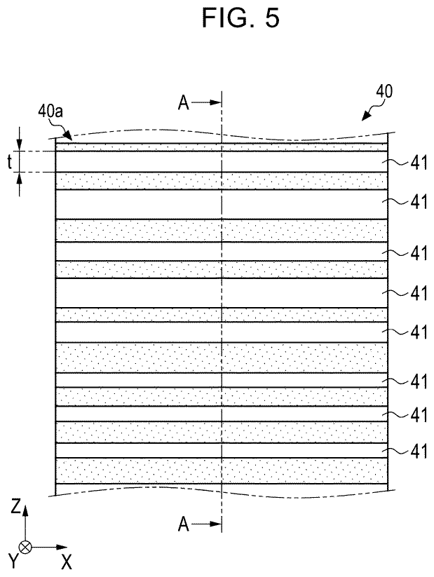

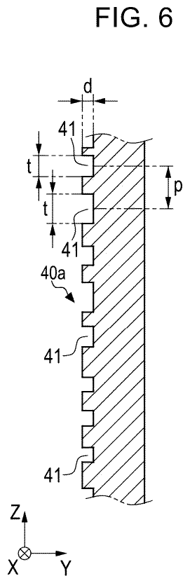

FIGS. 5 and 6 show the configuration of the insulating guide 40. FIG. 5 shows the surface 40a of the insulating guide 40. FIG. 6 shows a cross section taken along line A-A of FIG. 5.

As shown in FIG. 5, the plurality of grooves 41 extend in a direction parallel to the direction in which the laser gas flows, that is, in the X direction. In the present embodiment, as shown in FIG. 6, the cross section of each of the plurality of grooves 41 is quadrangular with a depth d and a width t being as respective sides. In the present embodiment, the plurality of grooves 41 have the same depth d. Here, the cross section is a cross-sectional plane obtained by cutting the groove 41 by a plane perpendicular to the direction in which the laser gas flows, that is, a YZ plane.

Further, the plurality of grooves 41 include a combination of two adjacent grooves 41 having cross-sectional shapes different from each other. It is preferable that 80% or more of all the grooves 41 have a cross-sectional shape different from that of the adjacent groove 41, and it is more preferable that all the grooves 41 each have a cross-sectional shape different from that of the adjacent groove 41. Here, a different cross-sectional shape means that at least one of the depth d and the width t is different. The depth d is a dimension of the groove 41 perpendicular to the surface 40a. The width t is a dimension of the groove 41 in a direction perpendicular to the extension direction and the direction of the depth d.

In the present embodiment, since all the grooves 41 are set to have the same depth d, having a different cross-sectional shape means having a different width t.

Further, regarding the arrangement of the plurality of grooves 41, it is preferable to include a combination in which an arrangement pitch p in the direction perpendicular to the extension direction of the grooves 41 and the direction of the depth d varies between the adjacent grooves 41. That is, it is preferable that at least one pitch of all the arrangement pitches p is different from the other pitch. Here, the arrangement pitch p refers to the distance between the center positions of two adjacent grooves 41.

When the wavelength of the acoustic wave generated by main discharge is λ, it is preferable that the width t satisfies Expression (1) below. Here, the wavelength λ is determined by the gas pressure, the gas type, the temperature, and the like of the laser gas in the container 10a.

λ/4≤t≤λ (1)

Since the wavelength λ is, for example, equal to or more than 7 mm and equal to or less than 10 mm, more specifically, it is preferable that the wavelength λ satisfies Expression (2) below.

1.75 mm≤t≤10 mm (2)

Further, it is also preferable that the depth d satisfies Expression (3) below in the same manner.

λ/4≤d≤λ (3)

Further, considering that the wavelength λ is, for example, equal to or more than 7 mm and equal to or less than 10 mm, it is also preferable that the depth d satisfies Expression (4) below.

1.75 mm≤d≤10 mm (4)

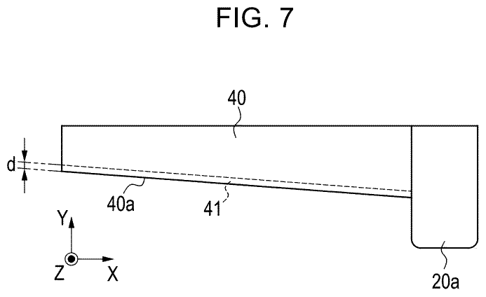

FIG. 7 shows the configuration of the groove 41 viewed from a direction of a side surface. In the present embodiment, the depth d of each groove 41 is constant in the extension direction.

### 2.2 Operation

The basic operation of the gas laser device 2 of the present embodiment is the same as that of the comparative example except that the insulating guide 40 exerts a peculiar effect with respect to attenuation of the acoustic wave.

When the acoustic wave is generated by main discharge, the acoustic wave may be reflected by various structures arranged in the container 10a and then returned to the discharge space 27. At this time, the acoustic wave may be reflected by the ground plate 21, the preionization electrode 30, or other structures, and then be incident on the insulating guide 40.

Specifically, the acoustic wave reflected by the preionization electrode 30 is incident at various positions of the plurality of grooves 41 formed on the surface 40a of the insulating guide 40 in paths to return to the discharge space 27 via the insulating guide 40.

Since the plurality of grooves 41 include the combination of two adjacent grooves 41having cross-sectional shapes different from each other, the acoustic wave reflected by the surface 40a is dispersed as components having various phases and reflection directions.

The acoustic wave reflected in this manner is attenuated as the coarse and dense wave components of the laser gas are weakened due to differences in phase and reflection direction.

### 2.3 Effect

In the present embodiment, the acoustic wave incident on and reflected by the insulating guide 40 is attenuated by being weakened by each other, so that the acoustic wave returning to the discharge space 27 is attenuated. Thus, the laser performance can be improved.

Further, even in the case of operation at a high repetition frequency with which the discharge interval is shortened, since the influence of the acoustic wave generated by previous main discharge on subsequent main discharge is suppressed, it is possible to realize a stable laser output even in a high throughput operating environment.

Further, since the plurality of grooves 41 are formed along a direction parallel to the direction in which the laser gas flows, the influence on the flow of the laser gas is small. Therefore, according to the present embodiment, it is possible to add the attenuation effect of the acoustic wave without adversely affecting the circulation performance of the laser gas.

In the present embodiment, the insulating guide 28a arranged upstream of the cathode electrode 20a inflow of the laser gas out of the insulating guides 28a, 28b in the comparative example is replaced with the insulating guide 40 in which the plurality of grooves 41 are formed. This is because the preionization electrode 30 is arranged upstream in flow of the laser gas, and the acoustic wave is considered to contain many components that are reflected by the preionization electrode 30 and incident on the insulating guide 28a. Therefore, by providing the insulating guide 40 upstream in flow of the laser gas, it is possible to effectively attenuate the acoustic wave returning to the discharge space 27.

Here, the insulating guide 28b arranged downstream of the cathode electrode 20a in flow of the laser gas may have a configuration in which a plurality of grooves 41 are formed in the same manner as the insulating guide 40. It is simply required that at least one of the insulating guides 28a, 28b of the comparative example has the same configuration as that of the insulating guide 40.

Further, the preionization electrode 30 is not limited to be provided on the upstream side in flow of the laser gas, and may be provided on the downstream side. The insulating guide 40 is preferably arranged at least on the side where the preionization electrode 30 is arranged so as to attenuate the acoustic wave incident on the insulating guide 28a from the preionization electrode 30 and reflected.

### 3. Modifications

In the following, various modifications of the insulating guide 40 will be described.

3.1 First modification

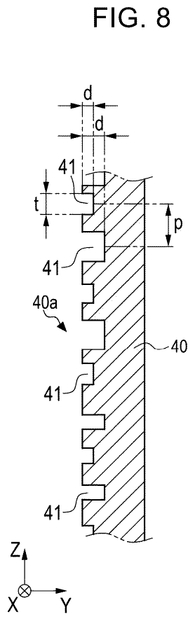

FIG. 8 shows a cross section of the insulating guide 40 according to a first modification. The configuration of the insulating guide 40 of the present modification is different from that of the above-described embodiment in that the depths d of two adjacent grooves 41 are different from each other. For example, grooves 41 having a first depth and grooves 41 having a second depth different from the first depth are alternately arranged on the surface 40a.

In the present modification, it is preferable that the depths d of all the grooves 41 formed on the surface 40a satisfy Expression (3) above.

Further, it is also preferable that the depths d of all the grooves 41 formed on the surface 40a satisfy Expression (4) above.

Further, the plurality of grooves 41 formed on the surface 40a may include grooves 41 having a depth d that satisfies Expression (3) above and grooves 41 having a depth d that does not satisfy Expression (3) above. For example, one of the first depth and the second depth may satisfy Expression (3) above, and the other may not satisfy Expression (3) above.

Further, the plurality of grooves 41 formed on the surface 40a may include grooves 41 having a depth d that satisfies Expression (4) above and grooves 41 having a depth d that does not satisfy Expression (4) above. For example, one of the first depth and the second depth may satisfy Expression (4) above, and the other may not satisfy Expression (4) above.

In the present modification, since the plurality of grooves 41 include a combination of two adjacent grooves 41 having different depths d as well as different widths t, the acoustic wave reflected by the surface 40a is further increased in the variability of the phase and the propagation direction. Thus, the attenuation effect of the acoustic wave is further improved.

### 3.2 Second Modification

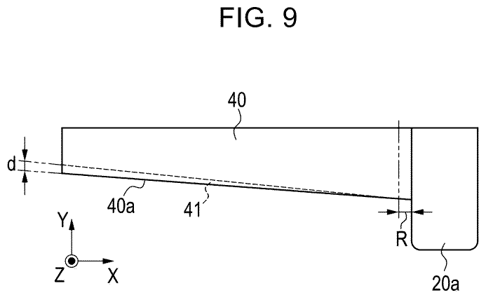

FIG. 9 shows the configuration of the groove 41 of the insulating guide 40 according to a second modification viewed from the direction of the side surface. The configuration of the insulating guide 40 of the present modification is different from that of the above-described embodiment in that the depth d of the grooves 41 is set to be larger on the side farther from the cathode electrode 20a than on the side closer to the cathode electrode 20a. Specifically, the depth d of the grooves 41 is set to gradually increase as the distance from the position of the cathode electrode 20a increases.

Further, the grooves 41 may not be formed in a close region R of the insulating guide 40 that is close to the cathode electrode 20a. For example, the close region R is a region being at equal to 10 mm or less from the cathode electrode 20a.

The depth d of the grooves 41 at the end opposite to the cathode electrode 20a preferably satisfies Expression (3) above or Expression (4) above.

In the present modification as well, as in the above-described embodiment, the attenuation effect of the acoustic wave can be obtained by diversifying the phase and the reflection direction of the acoustic wave reflected by the surface 40a. Further, by not forming the grooves 41 in the close region R to the cathode electrode 20a, the laser gas flow in the vicinity of the cathode electrode 20a is rectified without being disturbed. As a result, the circulation performance of the laser gas and the discharge characteristics are improved.

### 3.3 Third Modification

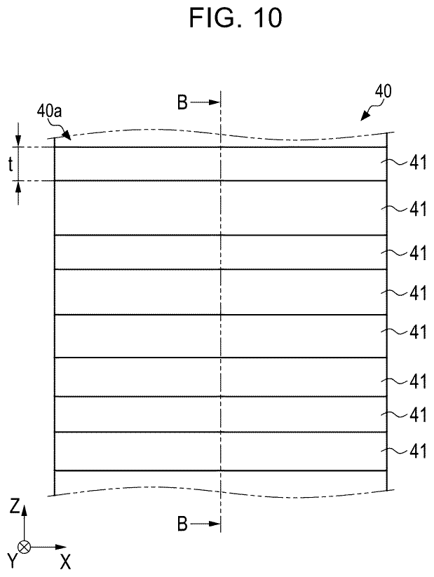

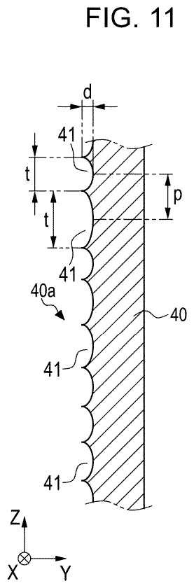

FIGS. 10 and 11 show the configuration of the insulating guide 40 according to a third modification. FIG. 10 shows the surface 40a of the insulating guide 40. FIG. 11 shows a cross section taken along line B-B of FIG. 10. The configuration of the insulating guide 40 of the present modification is different from that of the above-described embodiment in that the cross section of each groove 41 has an arc shape. The arc shape includes a part of a circle or a part of an ellipse.

The insulating guide 40 of the present modification has the same configuration as that of the above-described embodiment except for the cross-sectional shape of each groove 41. That is, the plurality of grooves 41 include a combination of two adjacent grooves 41 having cross-sectional shapes different from each other. Further, it is preferable to include a combination in which the arrangement pitch p varies between the adjacent grooves 41.

In the present modification as well, as in the first modification, the insulating guide 40 may be configured such that the depths d of the two adjacent grooves 41 are different from each other. Further, as in the second modification, the insulating guide 40 may be configured such that the depth d of the grooves 41 is larger on the side farther from the cathode electrode 20a than on the side closer to the cathode electrode 20a.

In the present modification, since the cross section of each groove 41 is arc-shaped, the phase and the reflection direction of the acoustic wave reflected by the surface 40a are more diversified. Thus, the attenuation effect of the acoustic wave is further improved.

### 3.4 Fourth Modification

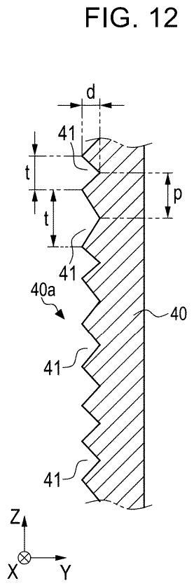

FIG. 12 shows a cross section of the insulating guide 40 according to a fourth modification. The configuration of the insulating guide 40 of the present modification is different from that of the third modification only in that the cross section of each groove 41 is triangular. The operation and effect of the present modification are the same as those of the third modification.

### 4. Electronic Device Manufacturing Method

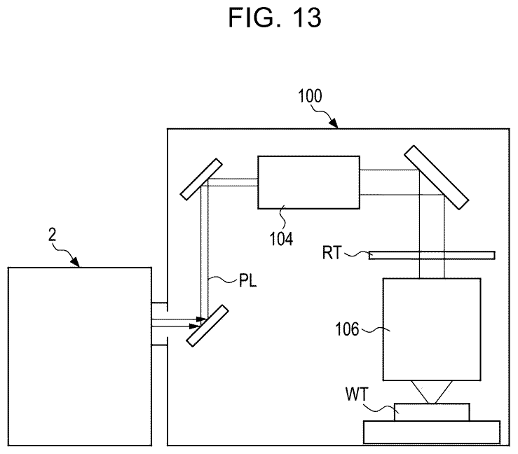

FIG. 13 schematically shows a configuration example of the exposure apparatus 100. The exposure apparatus 100 includes an illumination optical system 104 and a projection optical system 106. For example, the illumination optical system 104 illuminates a reticle pattern of a reticle (not shown) arranged on a reticle stage RT with the pulse laser light PL incident from the gas laser device 2. The projection optical system 106 causes the pulse laser light PL transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the pulse laser light PL reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

Here, not limited to the manufacturing of an electronic device, the gas laser device 2 may be used for laser processing such as drilling.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of the any thereof and any other than A, B, and C.

What is claimed is:

1. A laser chamber comprising:
a container filled with a laser gas;
a first electrode arranged in the container;
a second electrode arranged at a position closer to an inner wall of the container than the first electrode while facing the first electrode;
a fan configured to cause the laser gas to flow through a discharge space between the first electrode and the second electrode; and
an insulating guide arranged at least either on upstream or downstream of the second electrode in flow of the laser gas,
a plurality of grooves being formed on a surface of the insulating guide in a direction parallel to a direction in which the laser gas flows, and
the plurality of grooves including a combination of two adjacent grooves having cross-sectional shapes different from each other, the cross-sectional shapes being taken along a plane perpendicular to the direction in which the laser gas flows.

2. The laser chamber according to claim 1,
wherein 80% or more of the plurality of grooves have the cross-sectional shape different from that of an adjacent groove.

3. The laser chamber according to claim 1,
wherein all of the plurality of grooves each have the cross-sectional shape different from that of an adjacent groove.

4. The laser chamber according to claim 1,
wherein the combination is a combination of two adjacent grooves having different widths.

5. The laser chamber according to claim 1,
wherein the combination is a combination of two adjacent grooves having different depths.

6. The laser chamber according to claim 1,
wherein 1.75 mm≤d≤10 mm is satisfied, where d is a depth of each of the plurality of grooves.

7. The laser chamber according to claim 1,
wherein 1.75 mm≤t≤10 mm is satisfied, where t is a width of each of the plurality of grooves.

8. The laser chamber according to claim 1,
wherein the cross-sectional shape is quadrangular.

9. The laser chamber according to claim 1,
wherein the cross-sectional shape is an arc shape.

10. The laser chamber according to claim 1,
wherein the cross-sectional shape is triangular.

11. The laser chamber according to claim 1,
wherein a depth of each of the plurality of grooves is larger on a side farther from the second electrode than on a side closer to the second electrode.

12. The laser chamber according to claim 11,
wherein the plurality of grooves are not formed in a region close to the second electrode.

13. The laser chamber according to claim 1,
further comprising a preionization electrode arranged at least on upstream or downstream of the second electrode,
wherein the insulating guide is arranged on a side, with respect to the second electrode, where the preionization electrode is arranged.

14. A gas laser device comprising an optical resonator, and a laser chamber arranged so that an optical path of the optical resonator passes therethrough,
the laser chamber including:
a container filled with a laser gas;
a first electrode arranged in the container;
a second electrode arranged at a position closer to an inner wall of the container than the first electrode while facing the first electrode;
a fan configured to cause the laser gas to flow through a discharge space between the first electrode and the second electrode; and
an insulating guide arranged at least either on upstream or downstream of the second electrode in flow of the laser gas,
a plurality of grooves being formed on a surface of the insulating guide in a direction parallel to a direction in which the laser gas flows, and
the plurality of grooves including a combination of two adjacent grooves having cross-sectional shapes different from each other, the cross-sectional shapes being taken along a plane perpendicular to the direction in which the laser gas flows.

15. The gas laser device according to claim 14,
wherein 80% or more of the plurality of grooves have the cross-sectional shape different from that of an adjacent groove.

16. The gas laser device according to claim 14,
wherein all of the plurality of grooves each have the cross-sectional shape different from that of an adjacent groove.

17. The gas laser device according to claim 14,
wherein the combination is a combination of two adjacent grooves having different widths.

18. The gas laser device according to claim 14,
wherein the combination is a combination of two adjacent grooves having different depths.

19. The laser chamber according to claim 14,
wherein 1.75 mm≤d≤10 mm is satisfied, where d is a depth of each of the plurality of grooves.

20. An electronic device manufacturing method, comprising:
generating laser light using a gas laser device;
outputting the laser light to an exposure apparatus; and
exposing a photosensitive substrate to the laser light in the exposure apparatus to manufacture an electronic device,
the gas laser device including an optical resonator, and a laser chamber arranged so that an optical path of the optical resonator passes therethrough,
the laser chamber including:
a container filled with a laser gas;
a first electrode arranged in the container;
a second electrode arranged at a position closer to an inner wall of the container than the first electrode while facing the first electrode;
a fan configured to cause the laser gas to flow through a discharge space between the first electrode and the second electrode; and
an insulating guide arranged at least either on upstream or downstream of the second electrode in flow of the laser gas,
a plurality of grooves being formed on a surface of the insulating guide in a direction parallel to a direction in which the laser gas flows, and
the plurality of grooves including a combination of two adjacent grooves having cross-sectional shapes different from each other, the cross-sectional shapes being taken along a plane perpendicular to the direction in which the laser gas flows.
